(19) United States
(12) Patent Application Publication
(10) Pub. No.: US 2014/0344566 A1
(43) Pub. Date: Nov. 20, 2014

(54) Secure Cloud-Based Data Access System and Method

(71) Applicants: Kay Stephenson, Tallahassee, FL (US); Jonathan Waters, Tallahassee, FL (US)

(72) Inventors: Kay Stephenson, Tallahassee, FL (US); Jonathan Waters, Tallahassee, FL (US)

(21) Appl. No.: 13/896,734

(22) Filed: May 17, 2013

(51) Int. Cl. H04L 9/00

(52) U.S. Cl. CPC H04L 9/00
USPC 713/150

(57) ABSTRACT

A data storage and retrieval system suitable for use by law enforcement/criminal justice personnel and their designees. The invention creates secure connectivity over communications channels, such as the Internet, which are not considered secure under the mandate of the FBI's security policies. All of the communications are processed via a secure cloud, which processes, verifies and audits all data that passes through the system. The audited data is made available, immediately upon request by the FBI or other authorized agency.

### CROSS-REFERENCES TO RELATED APPLICATIONS

Pursuant to the provisions of 37 C.F.R. §1.53(c), this non-provisional application claims the benefit of an earlier-filed provisional patent application. The earlier application was assigned Ser. No. 61/648,332. It listed the same inventors.

### STATEMENT REGARDING FEDERALLY SPONSORED RESEARCH OR DEVELOPMENT

Not Applicable.

### MICROFICHE APPENDIX

Not Applicable member

### BACKGROUND OF THE INVENTION

1. Field of the Invention

This invention relates to the field of data storage and retrieval systems. More specifically, the invention comprises a communication system that allows law enforcement/criminal justice entities to store and retrieve data using a remote but secure data center that is not in a law enforcement/criminal justice controlled facility.

2. Description of the Related Art

Law Enforcement/Criminal Justice (“LE/CJ”) agencies have for many years maintained and managed searchable databases. These databases store information regarding crimes committed, known criminals, and other data of interest to the LE/CJ community. Most of these systems operate in a closed, proprietary environment. As an example, the database maintained by the State of Florida was traditionally houses within a secure state facility. Access to that database was limited to authorized members of the Florida LE/CJ community. Several agencies of the United States Government have operated similar proprietary systems.

The use of a proprietary system was at one time necessary for security reasons as the data that is transmitted over such networks is considered confidential and must be protected from unauthorized access. This approach, while effective, places physical and personnel cost burdens on the entity within the State that creates, maintains and operates the system and also limits the potential means by which authorized entities can access the critical information in question. Further, even a LE/CJ user in one state may not be able to access data available in another state's system.

Some standardization has taken place in recent years. The security requirements which must be followed by any and all systems and their users that process LE/CJ data are defined by the National Crime Information Center (hereafter referred to as “NCIC”), which is a division within the United State Federal Bureau of Investigation (hereafter referred to as “FBI”). These standards must be followed in order to interact with a LE/CJ database.

The description to follow uses acronyms, some of which may be unfamiliar to the reader. Accordingly, the following definitions may aid the reader's understanding:

“FBI”—The Federal Bureau of Investigation. A United States governmental agency that is part of the United States Department of Justice.

“NCIC”—The National Crime Information Center. This is a division within the FBI that maintains data of interest to the LE/CJ community.

“Nlets”—The National Law Enforcement Telecommunication System. A non-profit entity that provides a secure communication link between the state and federal entities for purposes of transmitting and receiving LE/CJ data.

“CJIS”—A general term for computer systems that access and/or maintain information of interest to the LE/CJ community. “CJIS” is generally understood to be an acronym standing for “criminal justice information system.” Thus, a “CJIS system” refers to a computer system used to access and/or maintain LE/CJ data.

“LE/CJ”—Refers to a law enforcement or criminal justice person, entity, or thing. Thus, an “LE/CJ facility” refers to a physical building used by law enforcement.

The prior art communication environment is hampered by the need to practice the older methods of secure communication. Specifically, most queries originate with a terminal that is physically located in an LE/CJ facility. Such queries are typically transmitted over a hard-wired connection.

Of course, the current communication paradigm has shifted to wireless communications and the storage of data in a dispersed “cloud.” Security is maintained by encryption rather than physical segregation. It would be preferable to allow authorized persons to interact with CJIS data using flexible and modern communication and data storage technologies, while maintain the required level of security. The present invention provides such a solution.

### BRIEF SUMMARY OF THE PRESENT INVENTION

The present invention comprises a data storage and retrieval system suitable for use by law enforcement/criminal justice personnel and their designees. The invention creates secure connectivity over communications channels, such as the Internet, which are not considered secure under the mandate of the FBI's security policies. All of the communications are processed via a secure cloud, which processes, verifies and audits all data that passes through the system. The audited data is made available, immediately upon request by the FBI or other authorized agency.

In a first embodiment of the invention, a CJIS entity and a non-CJIS entity (but who has received appropriate authorization and may or may not be related to a designated CJIS entity), by use of the invention, may access the secure cloud via an unsecure communications network (such as the Internet). Data is then forwarded via the secure cloud through a secure communications network (such as the Nlets encrypted network), thus allowing two-way communications between the CJIS or non-CJIS entity and authorized international, federal, state, local, or other LE/CJ-related data sources.

In a second embodiment of the invention, a CJIS entity and a non-CJIS entity (but who has received appropriate authorization and may or may not be related to a designated CJIS entity), by use of the invention, may access the secure cloud via a secure communications network (such as the Nlets encrypted network). Data is then forwarded via the secure cloud through a secure communications network (such as the Nlets encrypted network), thus allowing two-way communications between the CJIS or non-CJIS entity and authorized international, federal, state, local, or other LE/CJ-related data sources.

In a third embodiment of the invention, a CJIS entity and a non-CJIS entity (but who has received appropriate authorization and may or may not be related to a designated CJIS entity), by use of the invention, may access the secure cloud via a state network. Data is then forwarded via the secure cloud through a secure communications network (such as the Nlets encrypted network), thus allowing two-way communications between the CJIS or non-CJIS entity and authorized international, federal, state, local, or other LE/CJ-related data sources.

In a fourth embodiment of the invention, a CJIS entity and a non-CJIS entity (but who has received appropriate authorization and may or may not be related to a designated CJIS entity), by use of the invention, may access the secure cloud via an unsecure communications network (such as the Internet). Data is then forwarded via the secure cloud through a secure communications network (such as the Nlets encrypted network) to a server or servers controlled by Nlets. The Nlets server facilitates all communication with authorized international, federal, state, local, or other LE/CJ-related data sources, thus allowing two-way communications between the CJIS or non-CJIS entity and the desired data sources.

In a fifth embodiment of the invention, a CJIS entity and a non-CJIS entity (but who has received appropriate authorization and may or may not be related to a designated CJIS entity), by use of the invention, may access the secure cloud via a secure communications network (such as the Nlets encrypted network). Data is then forwarded via the secure cloud through a secure communications network (such as the Nlets encrypted network) to a server or servers controlled by Nlets. The Nlets server facilitates all communication with authorized international, federal, state, local, or other LE/CJ-related data sources, thus allowing two-way communications between the CJIS or non-CJIS entity and the desired data sources.

In a sixth embodiment of the invention, a CJIS entity and a non-CJIS entity (but who has received appropriate authorization and may or may not be related to a designated CJIS entity), by use of the invention, may access the secure cloud via a state network. Data is then forwarded via the secure cloud through a secure communications network (such as the Nlets encrypted network) to a server or servers controlled by Nlets. The Nlets server facilitates all communication with authorized international, federal, state, local, or other LE/CJ-related data sources, thus allowing two-way communications between the CJIS or non-CJIS entity and the desired data sources.

### BRIEF DESCRIPTION OF THE SEVERAL VIEWS OF THE DRAWINGS

FIG. 1 is a block diagram, showing an embodiment in which both CJIS and non-CJIS entities access the secure cloud via the invention over an unsecure communications network and communication between the secure cloud and other international, federal, state, local, and other data sources is facilitated via a secure communications network and/or state network.

FIG. 2a is a block diagram, showing an embodiment in which both CJIS and non-CJIS entities access the secure cloud via the invention over a secure communications network and communication between the secure cloud and other international, federal, state, local, and other data sources is facilitated via a secure communications network and/or state network.

FIG. 2b is a block diagram, showing an embodiment in which both CJIS and non-CJIS entities access the secure cloud via use of the invention over a state network and communication between the secure cloud and other international, federal, state, local, and other data sources is facilitated via a secure communications network and/or state network.

FIG. 3 is a block diagram, showing an embodiment in which both CJIS and non-CJIS entities access the secure cloud via use of the invention over an unsecure communications network and communication between the secure cloud and other international, federal, state, local, and other data sources is facilitated via the Nlets server.

FIG. 4a is a block diagram, showing an embodiment in which both CJIS and non-CJIS entities access the secure cloud via use of the invention over a secure communications network and communication between the secure cloud and other international, federal, state, local, and other data sources is facilitated via the Nlets server.

FIG. 4b is a block diagram, showing an embodiment in which both CJIS and non-CJIS entities access the secure cloud via use of the invention over a state network and communication between the secure cloud and other international, federal, state, local, and other data sources is facilitated via the Nlets server.

FIG. 5 is a block diagram, showing the flow of a transaction from a CJIS or non-CJIS entity to a data provider.

FIG. 6 is a block diagram, showing the flow of a transaction from a data provider to a secure cloud server or CJIS or non-CJIS entity.

FIG. 7 is a block diagram, showing the flow of a transaction from a secure cloud server to data providers or CJIS or non-CJIS entities.

### DETAILED DESCRIPTION OF THE INVENTION

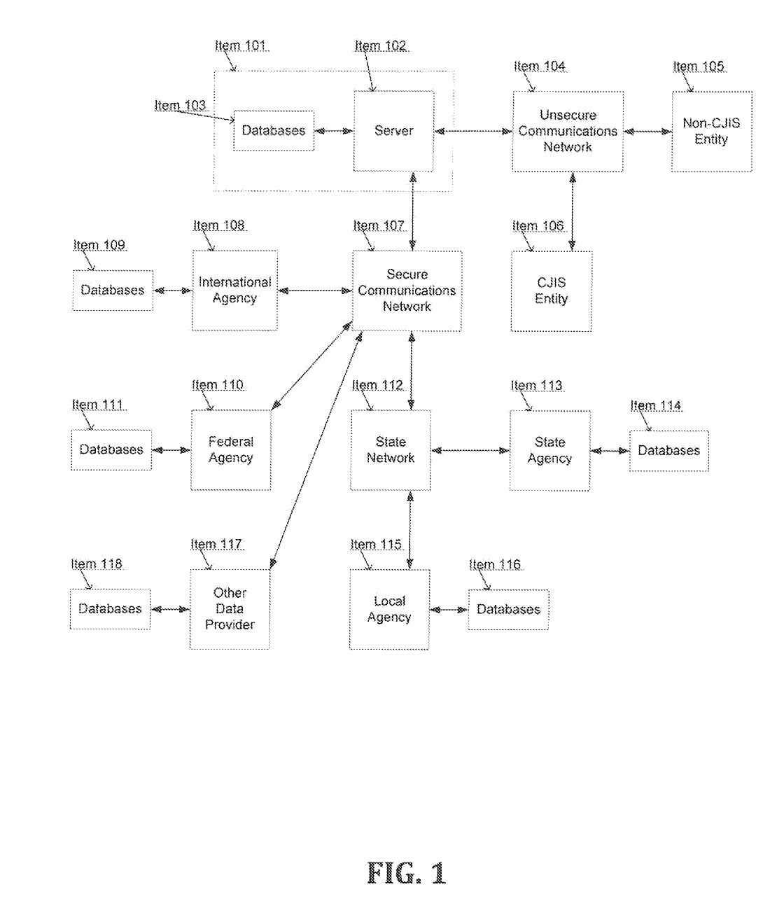

The secure cloud used in the specific embodiments described hereafter is run by DATAMAXX, Inc. The secure cloud is therefore referred to as the “DATAMAXX secure cloud.” or “DSC.” In FIG. 1, Item 101 represents the DSC. The DSC is located in a non-LE/CJ controlled facility. It is however a secure facility able to send, receive, process, analyze, store, and log LE/CJ transactions in accordance with the standards applicable to NCIC-approved facilities. The overall security of the DSC is preferably maintained using the following:
1. Regularly reviewing the CJIS Security Policy (issued by the FBI) to ensure that persons working with the DSC are aware of the latest security standards and comply with those standards;
2. Performing background checks for all personnel working with the DSC;
3. Performing fingerprint checks on all personnel working with the DSC;
4. Securing the physical premises where equipment related to the DSC is located, including:
   a. video surveillance,
   b. keypass access control.
   c. biometric-based access to more sensitive areas,
   d. inclusion of a fire suppression system,
   e. a backup power source,
   f. a visitor management system;
5. Securing the network used by the DSC with a variety of technologies including:
   a. firewalls,
   b. anti-virus software,
   c. intrusion detection systems,
   d. ethical hacking tests,
   e. network security scans,
   f. encrypting all communications of CJIS data outside the DSC to current NCIC encryption standards or better; and
6. Providing security awareness training for all personnel working with the DSC.

All aspects of the DSC and its operations and interactions with other entities will be made available for audit by authorized LE/CJ agencies that are the sources of the LE/CJ information being handled by the DSC.

Item 102 represents the server(s) located within the DSC 101 that send, receive, process, analyze, store and log transactions and LE/CJ data sent and/or received from: CJIS entities 106, non-CJIS entities 105, Federal Agencies 110, State Agencies 113. Local Agencies 115, International Agencies 108, and other data providers 117. The sending, receiving, processing, analyzing, storing, and logging of transactions and LE/CJ data may be performed by computer applications or solutions provided by DATAMAXX or other providers.

Item 103 represents the databases used by the server(s) 102 for purposes of processing, analyzing, storing and logging transactions in addition to LE/CJ data. These databases may store LE/CJ-related data on behalf of an agency which owns the data and as such may represent data that CJIS entities 106 and non-CJIS entities 105 may wish access to.

Item 104 represents any unsecure communications network which a CJIS 106 or non-CJIS 105 entity will utilize to establish communications with the DSC 101. Examples of such unsecure communications networks comprise:

1. The Internet;

2. Dedicated wide area network circuits, such as T1, DS3, or MPLS circuits, provided by such third-party vendors as SPRINT or LEVEL3 COMMUNICATIONS;

3. Wireless networks, such as Wi-Fi or cellular.

The invention creates secure, encrypted communication paths between the CJIS 106 and non-CJIS 105 entities and the DSC 101 through unsecure communications networks such that all communications between the CJIS 106 and non-CJIS 105 entities and the DSC 101 over such unsecure communications networks which involves LE/CJ data or other sensitive information such as user or device identification and credentials is encrypted according to current CJIS Security Policy encryption standards. These standards change based on feedback from and the requirements of the LE/CJ community as well as based on advances in technology. The DSC employees regularly review these standards to ensure the DSC is meeting or exceeding them.

Item 105 represents a non-CJIS entity that has been authorized to send and/or receive LE/CJ transactions or transactions needed for LE/CJ purposes. This entity accesses the DSC 101 via an unsecure communications network 104. The transactions that are sent and/or received might include:

1. User-initiated transactions, where an authorized user initiates a specific transactions to one or more secure data sources accessed via DSC 101:

2. User-destined transactions, where an authorized automated system initiates a transaction to one or more secure data sources accessed via DSC 101, based on other data the automated system has processed; and

3. System-destined transactions, where an authorized automated system receives a specific transaction send from one or more secure data sources accessed via DSC 101 which it will process and handle according to its own requirements.

Item 106 represents a CJIS entity that has been authorized to send and/or receive LE/CJ transactions or transactions needed for LE/CJ purposes. This entity accesses the DSC 101 via an unsecure communications network 104. The transactions that are sent and/or received might include:

1. User initiated transactions, where an authorized user initiates a specific transactions to one or more secure data sources accessed via DSC 101;

2. User-destined transactions, where an authorized user receives a specific transaction sent from one or more secure data sources accessed via DSC 101;

3. System-initiated transactions, where an authorized automated system initiates a transaction to one or more secure data sources accessed via DSC 101, based on other data the automated system has processed; and

4. System-destined transactions, where an authorized automated system receives a specific transaction send from one or more secure data sources accessed via DSC 101 which it will process and handle according to its own requirements.

Item 107 represents a secure communications network used to facilitate secure communications between the DSC 101 and International Agencies 108, Federal Agencies 110, and State Networks 112. All communications over such secure networks are encrypted to meet CJIS Security Policy standards for networks transmitting CJIS-related data. Examples of such a network comprise:

1. The Nlets-encrypted communications network. End-to-end encryption on this network is provided by Nlets and meets current CJIS Security Policy standards;

2. Dedicated wide area network circuits, such as T1, DS3, or MPLS circuits, which have been secured at both ends of the connection by using encryption functions. The encryption functions are controlled by the LE/CJ agency being reached at one end and DSC 101 at the other end, such that any data traversing the circuit controlled by the third-party vendor is encrypted to meet current CJIS Security Policy standards; and

3. The Internet, where each end of the connection between DSC 101 and the LEiCJ agency being reached is secured using encryption functions meeting the current CJIS Security Policy standards.

Item 108 represents an International Agency with secure data, examples of which might be the International Criminal Police Organization (INTERPOL) or the Royal Canadian Mounted Police, with which CJIS 106 and non-CJIS 105 entities desire to communicate.

Item 109 represents the databases with secure data controlled by an International Agency 108. Item 110 represents a Federal Agency with secure data, an example of which might be the NCIC, with which CJIS 106 and non-CJIS 105 entities desire to communicate. Item 111 represents the databases with secure data controlled by a Federal Agency 110. Item 112 represents a State's communications network, through which communications with State Agencies 113 and Local Agencies 115 may be facilitated. Methods for accessing the secure data located at State Agencies 113 and Local Agencies 115 comprise:

1. Utilizing a message processing system located within the State's communications network which then connects to all necessary State Agencies 113 and Local Agencies 115, allowing a single transaction sent to the message processing system to then retrieve all relevant information from State Agencies 113 and Local Agencies 115; and

2. Utilizing the State's communications network 112 as an extension of the Secure Communications Network 107 to connect directly to the State Agencies 113 and Local Agencies 115.

Item 113 represents a State Agency with secure data, examples of which might be the Department of Motor Vehicles or Department of Public Safety, with which CJIS 106 and non-CJIS 105 entities desire to communicate. Item 114 represents the databases with secure data controlled by a State Agency 113.

Item 115 represents a Local Agency within a State with secure data, an example of which might be a local police department's arrest records, with which CJIS 106 and non-CJIS 105 entities desire to communicate. Item 116 represents the databases with secure data controlled by a Local Agency 115.

Item 117 represents other providers of data that is of interest to CJIS 106 and non-CJIS 105 entities for LE/CJ purposes, examples of which might be providers of hazardous materials information or wants and warrants information from a local law enforcement agency. Item 118 represents the databases with data relevant to LE/CJ purposes and which are controlled by other data providers 117.

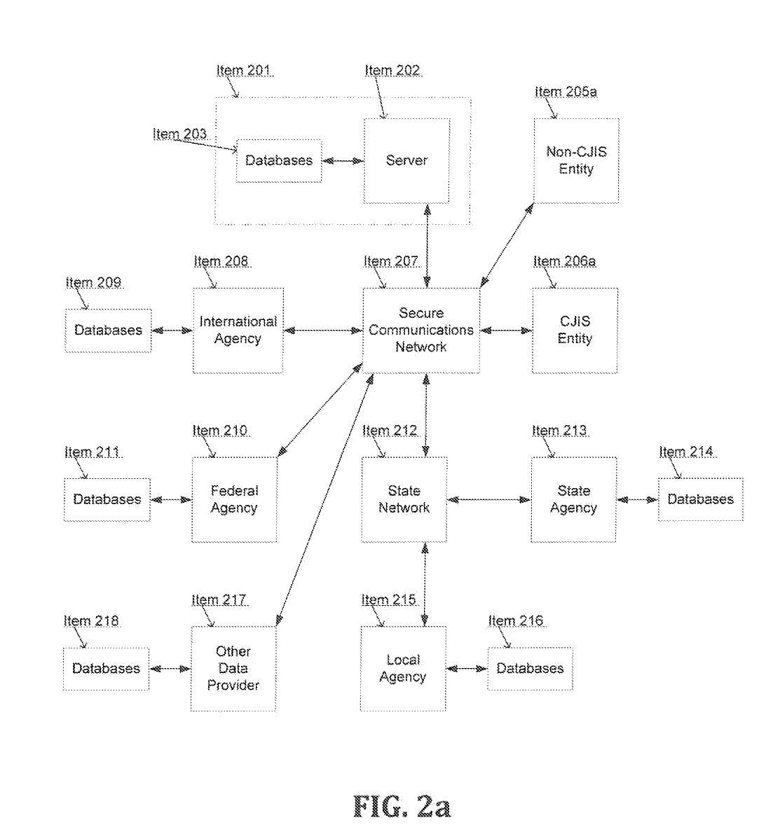

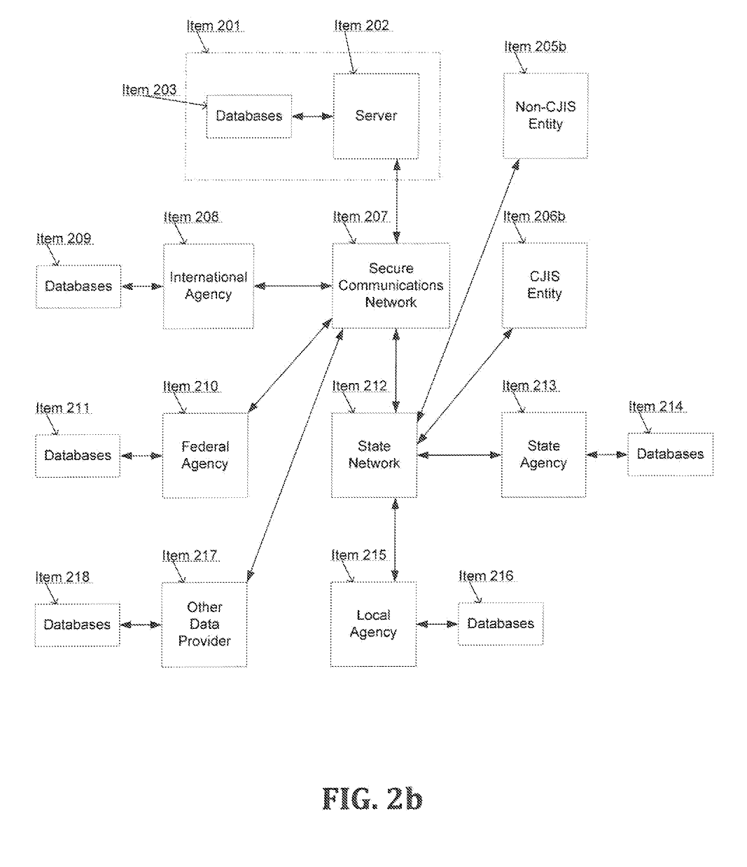

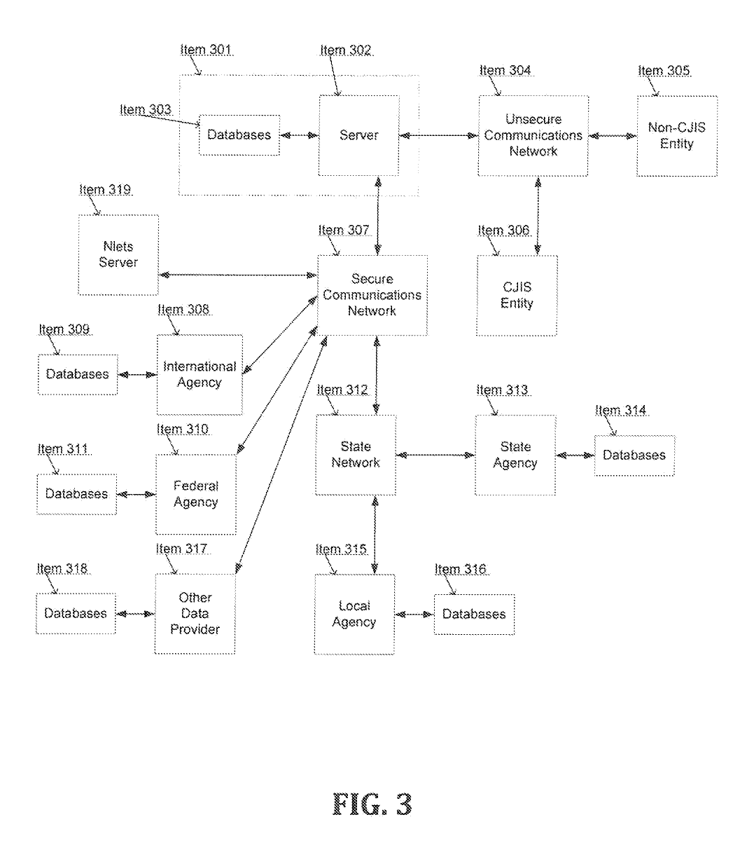

Turning now to FIGS. 2a and 2b, the differences between these embodiments and the embodiment depicted in FIG. 1 will be explained. In the embodiment of FIG. 2a, the communication with the DSC 201 passes exclusively through secure communication network 207. The other components are the same as shown in FIG. 1. The reader should note that the reference numerals used in the figures change according to the figure number. As an example, the DSC is labeled as “101” in FIG. 1, “201” in FIGS. 2a and 2b, “301” in FIG. 3, etc.

In the embodiment of FIG. 2b, the communications with non-CJIS entity 205b. CJIS entity 206b, and state agency 213 all take place via state network 212. State network 212 exchanges data with secure communication network 207, which exchanges data with DSC 201.

In the embodiment of FIG. 3, CJIS entity 306 and non-CJIS entity 305 communicate with unsecure communications network 304. Unsecure communications network 304 then communicates with DSC 301. Nlets server 319 communicates with secure communications network 307, which in turn communicates with DSC 301.

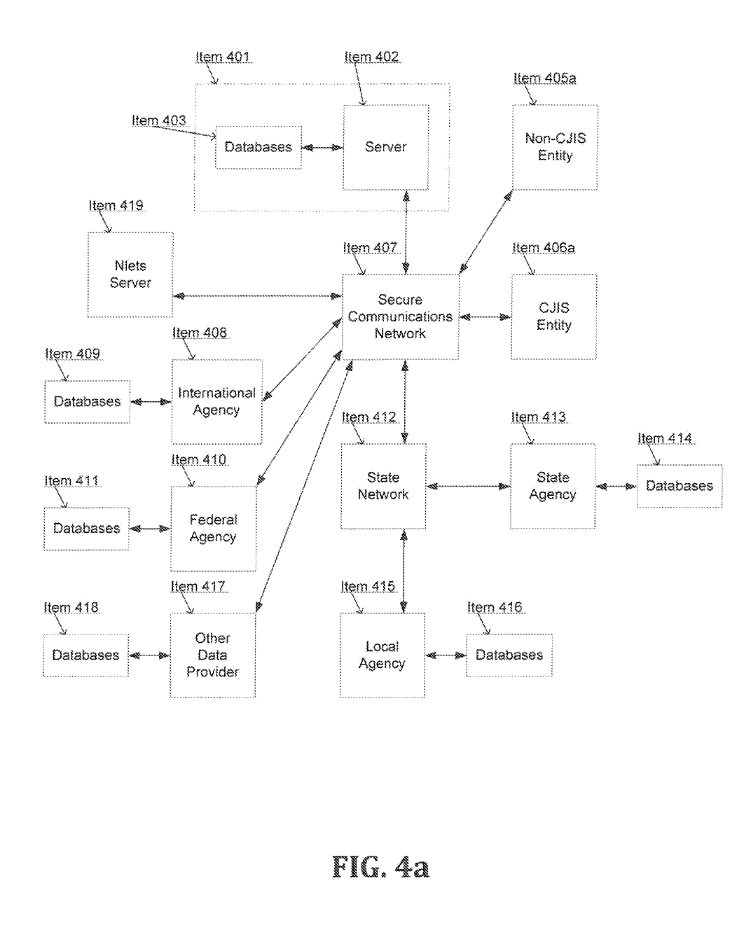

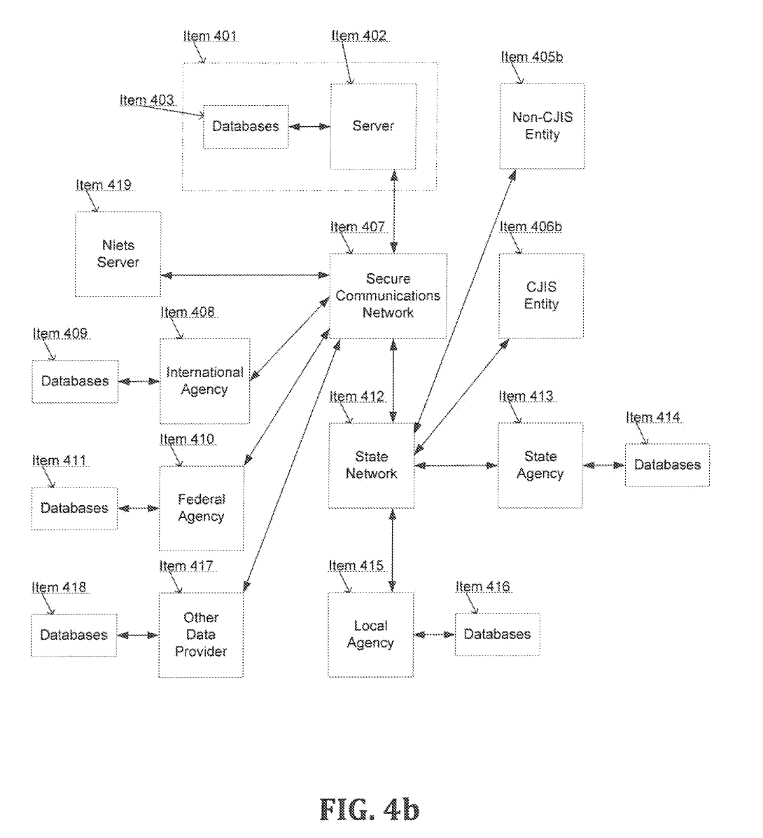

In the embodiment of FIG. 4a, both non-CJIS entity 405a and CJIS entity 406a communicate through secure communications network 407. The secure communications network 407 then communicates with DSC 401.

In the embodiment of FIG. 4b, a non-CJIS entity 405b, CJIS entity 406b, and state agency 413 all communicate through state network 412. The state network then communicates through secure communications network 407, which is tied to DSC 401.

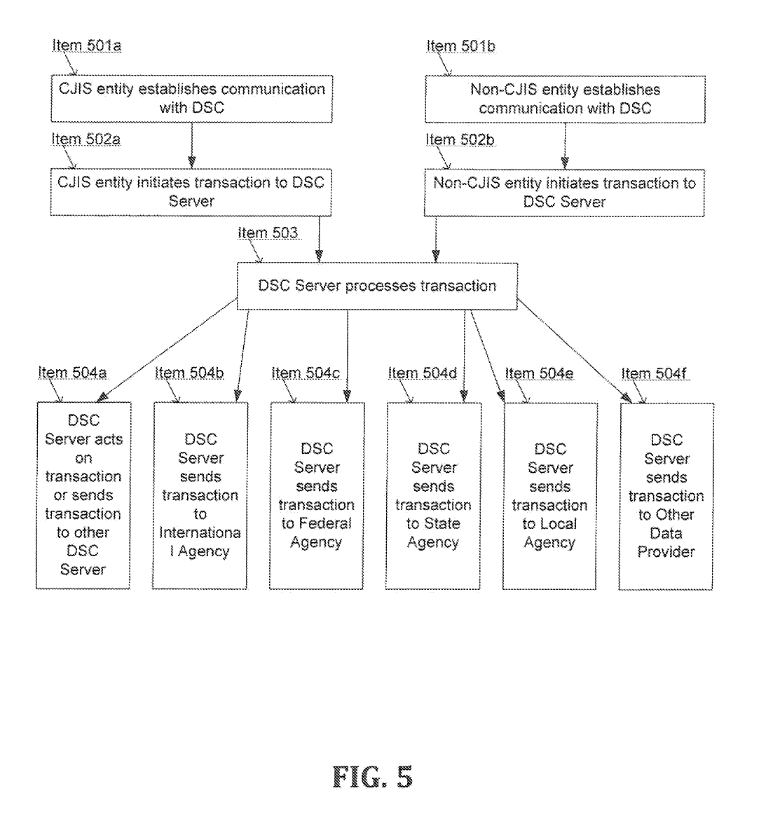

Item 501a in FIG. 5 depicts a CJIS entity (106/206a/206b/306/406a/406b) establishing a secure communications connection to the DSC (101/201/301/401). Examples of this might include:

1. CJIS entity (106/206a/206b/306/406a/406b) establishing an HTTPS session with the DSC server, where the DSC server only negotiates encryption options with the CJIS entity, where the encryption options comply with current CJIS Security Policy;

2. CJIS entity (106/206a/206b/306/406a/406b) using an application provided by a vendor which establishes a secure encrypted path between the CJIS entity and the DSC or DSC server, where the security provided by the application meets or exceeds current CJIS policy guidelines;

3. CJIS entity (206a) establishing a connection to a secure communications network 207 and through that connecting to the DSC server 202; and

4. CJIS entity (206b) establishing a connection to a State Network (212) and through that connecting to the DSC server (202).

Item 501b in FIG. 5 represents a non-CJIS entity (105/205a/205b/305/405a/405b) establishing a secure communications connected to DSC (101/201/301/401). Examples of this include:

1. Non-CJIS entity (105/205a/205b/305/405a/405b) establishing an HTTPS session with the DSC server, where the DSC server only negotiates encryption options with the non-CJIS entity, where the encryption options comply with current CJIS Security Policy;

2. Non-CJIS entity (105/205a/205b/305/405a/405b) using an application provided by a vendor which establishes a secure encrypted path between the non-CJIS entity and the DSC or DSC server, where the security provided by the application meets or exceeds current CJIS policy guidelines;

3. Non-CJIS entity (205a) establishing a connection to a secure communications network 207 and through that connecting to the DSC server 202: and

4. Non-CJIS entity (205b) establishing a connection to a State Network (212) and through that connecting to the DSC server (202).

Item 502a in FIG. 5 represents a CJIS entity (106/206a/206b/306/406a/406b) sending a transaction to the DSC Server (102/202/302/402). Item 502b in FIG. 5 represents a CJIS entity (105/205a/205b/305/405a/405b) sending a transaction to the DSC Server (102/202/302/402).

Item 503 in FIG. 5 represents the DSC Server (102/202/302/402) processing the transaction it has received and taking one or more actions based on that transaction. The actions taken might comprise one or more of the following:

1. Item 504a represents the situation where the DSC Server (102/202/302/402) that received the transaction or another DSC Server (102/202/302/402) within the DSC (101/201/301/401) is needed to take an action beyond forwarding the transaction to another data provider. An example of this situation might be the DSC Server (102/202/302/402) inserting data into or retrieving data from a Database (103/203/303/403);

2. Item 504b represents the situation where the DSC Server (102/202/302/402), upon analyzing and processing the received transaction, determines that it must send a transaction to an International Agency (108/208/308/408);

3. Item 504c represents the situation where the DSC Server (102/202/302/402), upon analyzing and processing the received transaction, determines that it must send a transaction to a Federal Agency (110/210/310/410);

4. Item 504d represents the situation where the DSC Server (102/202/302/402), upon analyzing and processing the received transaction, determines that it must send a transaction to a State Agency (113/213/313/413);

5. Item 504e represents the situation where the DSC Server (102/202/302/402), upon analyzing and processing the received transaction, determines that it must send a transaction to a Local Agency (115/215/315/415);

6. Item 504f represents the situation where the DSC Server (102/202/302/402), upon analyzing and processing the received transaction, determines that it must send a transaction to an Other Data Provider (117/217/317/417).

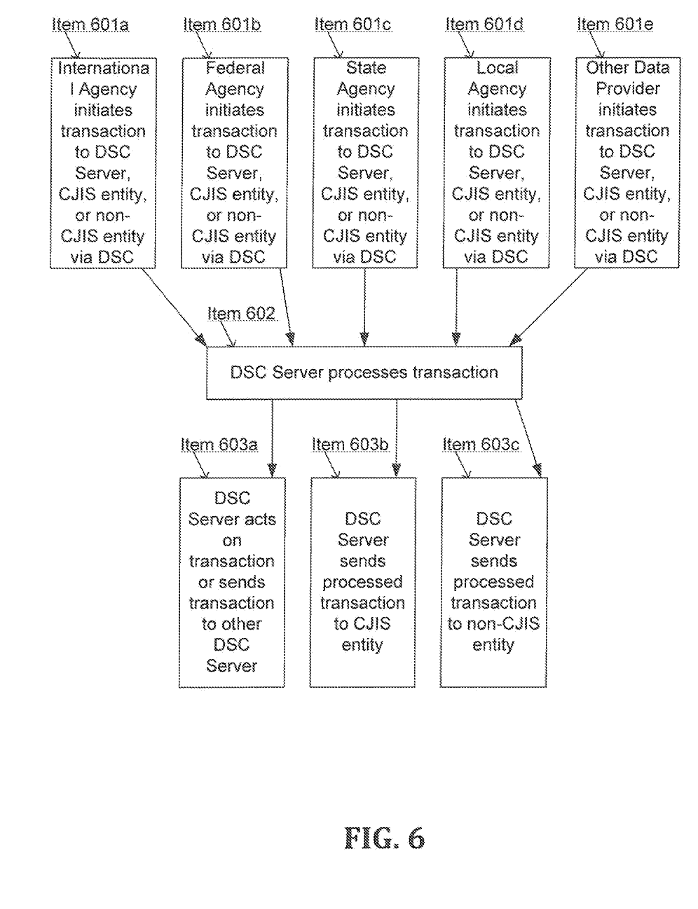

Item 601a in FIG. 6 represents the situation where an International Agency (108/208/308/408) sends a transaction to a DSC Server (102/202/302/402) where the intended recipient of the transaction might be one or more of: a DSC Server (102/202/302/402), CJIS entity (106/206a/206b/306/406a/406b) or non-CJIS entity (105/205a/205b/305/405a/405b). This may have been initiated by the sender in response to a previously received transaction received from one or more of the recipients or triggered by some other mechanism not directly related to the intended recipient(s) of this new message.

Item 601b represents the situation where a Federal Agency (110/210/310/410) sends a transaction to a DSC Server (102/202/302/402) where the intended recipient of the transaction might be one or more of: a DSC Server (102/202/302/402), CJIS entity (106/206a/206b/306/406a/406b) or non-CJIS entity (105/205a/205b/305/405a/405b). This may have been initiated by the sender in response to a previously received transaction received from one or more of the recipients or triggered by some other mechanism not directly related to the intended recipient(s) of this new message.

Item 601c represents the situation where a State Agency (113/213/313/413) sends a transaction to a DSC Server (102/202/302/402) where the intended recipient of the transaction might be one or more of: a DSC Server (102/202/302/402), CJIS entity (106/206a/206b/306/406a/406b) or non-CJIS entity (105/205a/205b/305/405a/405b). This may have been initiated by the sender in response to a previously received transaction received from one or more of the recipients or triggered by some other mechanism not directly related to the intended recipient(s) of this new message.

Item 601d represents the situation where a Local Agency (115/215/315/415) sends a transaction to a DSC Server (102/202/302/402) where the intended recipient of the transaction might be one or more of: a DSC Server (102/202/302/402), CJIS entity (106/206a/206b/306/406a/406b) or non-CJIS entity (105/205a/205b/305/405a/405b). This may have been initiated by the sender in response to a previously received transaction received from one or more of the recipients or triggered by some other mechanism not directly related to the intended recipient(s) of this new message.

Item 601e represents the situation where an Other Data Provider (117/217/317/417) sends a transaction to a DSC Server (102/202/302/402) where the intended recipient of the transaction might be one or more of: a DSC Server (102/202/302/402), CJIS entity (106/206a/206b/306/406a/406b) or non-CJIS entity (105/205a/205b/305/405a/405b). This may have been initiated by the sender in response to a previously received transaction received from one or more of the recipients or triggered by some other mechanism not directly related to the intended recipient(s) of this new message.

Item 602 represents the DSC Server (102/202/302/402) processing the transaction it has received and taking one or more actions based on that transaction. The actions taken might comprise one or more of the following:

1. Item 603a represents the situation where the DSC Server (102/202/302/402) that received the transaction or another DSC Server (102/202/302/402) within the DSC (101/201/301/401) is needed to take an action beyond forwarding the transaction to another recipient. An example of this situation might be the DSC Server (102/202/302/402) inserting data into or retrieving data from a Database (103/203/303/403);

2. Item 603b represents the situation where the DSC Server (102/202/302/402), upon analyzing and processing the received transaction, determines that it must send a transaction to a CJIS Entity (106/206a/206b/306/406a/406b); and

3. Item 603c represents the situation where the DSC Server (102/202/302/402), upon analyzing and processing the received transaction, determines that it must send a transaction to a non-CJIS Entity (105/205a/205b/305/405a/405b).

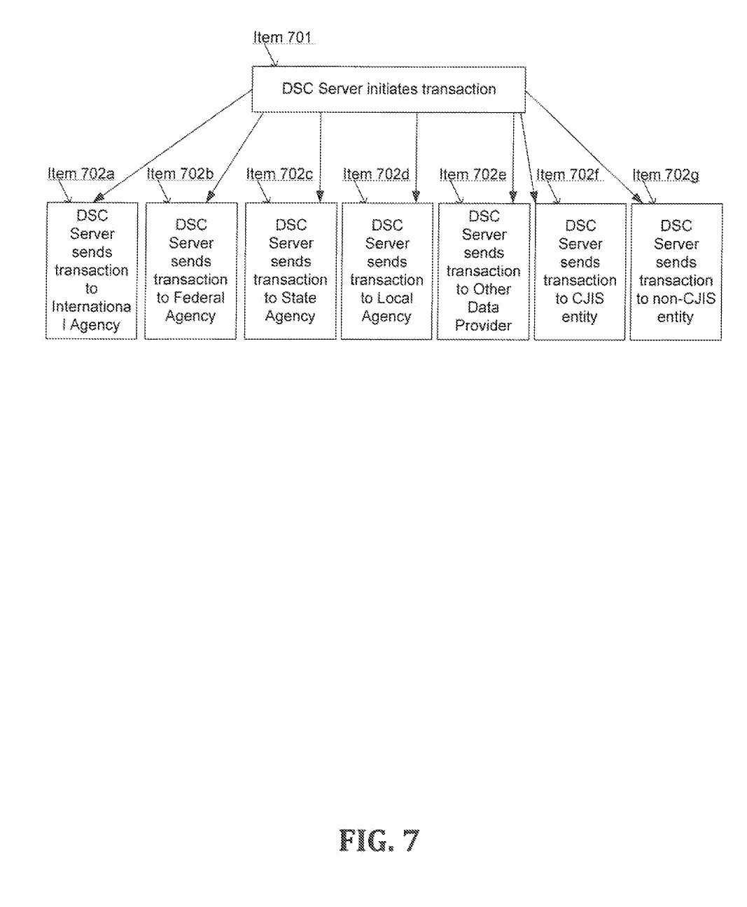

Item 701 in FIG. 7 represents the situation where a DSC Server (102/202/302/402) sends a transaction to one or more recipients. This may have been initiated by the sender in response to a previously received transaction received from one or more of the recipients or triggered by some other mechanism not directly related to the intended recipient(s) of this new message. The intended recipient might comprise one or more of:

1. Item 702a represents the situation where the transaction is sent to an international Agency (108/208/308/408). It may be necessary for the sending DSC Server to send the transaction via another DSC Server which has a communications connection to the intended recipient;

2. Item 702b represents the situation where the transaction is sent to a Federal Agency (110/210/310/410). It may be necessary for the sending DSC Server to send the transaction via another DSC Server which has a communications connection to the intended recipient;

3. Item 702c represents the situation where the transaction is sent to a State Agency (113/213/313/413). It may be necessary for the sending DSC Server to send the transaction via another DSC Server which has a communications connection to the intended recipient;

4. Item 702d represents the situation where the transaction is sent to a Local Agency (115/215/315/415). It may be necessary for the sending DSC Server to send the transaction via another DSC Server which has a communications connection to the intended recipient;

5. Item 702e represents the situation where the transaction is sent to an Other Data Provider (117/217/317/417). It may be necessary for the sending DSC Server to send the transaction via another DSC Server which has a communications connection to the intended recipient;

6. Item 702f represents the situation where the transaction is sent to a CJIS Entity (106/206a/206b/306/406a/406b). It may be necessary for the sending DSC Server to send the transaction via another DSC Server which has a communications connection to the intended recipient; and

7. Item 702g represents the situation where the transaction is sent to a non-CJIS Entity (105/205a/205b/305/405a/405b). It may be necessary for the sending DSC Server to send the transaction via another DSC Server which has a communications connection to the intended recipient.

The invention allows the non-LE/CJ controlled but secure facility to access International data sources, comprising of Canadian Police Information Center files, individual Canadian province motor vehicle files, the International Criminal Police Organization, amongst others.

The invention allows the non-LE/CJ controlled but secure facility to access Federal data sources, comprising National Crime Information Center, persons and property files, national gun check system, criminal history index, amongst others.

The invention allows the non-LE/CJ controlled but secure facility to access individual State data sources, comprising Department of Motor Vehicles, sex offender, criminal history, gun permits, corrections information, warrant information, amongst others.

The invention allows the non-LE/CJ controlled but secure facility to access Local municipal data sources, comprising local records such as violations, warrant information, amongst others.

The invention allows the non-LE/CJ controlled but secure facility to access other data sources of interest to LE/CJ entities for law-enforcement purposes, comprising of Hazardous Materials, Aircraft Registration, amongst others.

The invention allows the non-LE/CJ controlled but secure facility to access, via Nlets server(s), International data sources, comprising of Canadian Police Information Center files, individual Canadian province motor vehicle files, the International Criminal Police Organization, amongst others.

The invention allows the non-LE/CJ controlled but secure facility to access, via Nlets server(s), Federal data sources, comprising National Crime Information Center, persons and property files, national gun check system, criminal history index, amongst others.

The invention allows the non-LE/CJ controlled but secure facility to access, via Nlets server(s), individual State data sources, comprising Department of Motor Vehicles, sex offender, criminal history, gun permits, corrections information, warrant information, amongst others.

The invention allows the non-LE/CJ controlled but secure facility to access, via Nlets server(s), Local municipal data sources, comprising local records such as violations, warrant information, amongst others.

The invention allows the non-LECJ controlled but secure facility to access, via Nlets server(s), other data sources of interest to LE/CJ entities fir law-enforcement purposes, comprising of Hazardous Materials, Aircraft Registration, amongst others

The invention allows Criminal Justice and Law Enforcement to access via direct end user interface the secure facility via secure communications for purposes of accessing and maintaining data from Federal, State, Local, and International data sources which the secure facility allows access to.

The invention allows Criminal Justice and Law Enforcement to access via programmatic interface the secure facility via secure communications for purposes of accessing and maintaining data from Federal, State, Local, and International data sources which the secure facility allows access to.

The invention allows non-Criminal Justice and Law Enforcement to access via direct end user interface the secure facility via secure communications for purposes of accessing and maintaining data from Federal, State, Local, and International data sources which the secure facility allows access to.

The invention allows non-Criminal Justice and Law Enforcement to access via programmatic interface the secure facility via secure communications for purposes of accessing and maintaining data from Federal, State, Local, and International data sources which the secure facility allows access to.

Although the preceding description contains significant detail, it should not be construed as limiting the scope of the invention but rather as providing illustrations of the preferred embodiments of the invention. Thus, the scope of the present invention should be fixed by the claims rather than the specific examples given.

1. A method for allowing CJIS and non-CJIS entities to communicate over an unsecure network using a secure cloud, comprising:
a. providing a secure cloud including a server and a plurality of cloud-based databases;
b. providing an unsecure communications network in communication with said secure cloud;
c. providing a secure communications network in communication with said secure cloud;
d. providing a communication link between said non-CJIS entity and said unsecure communications network; and
e. providing a communication link between said CJIS entity and said unsecure communications network;
